(19) United States
(12) Patent Application Publication
(10) Pub. No.: US 2021/0026543 A1
(43) Pub. Date: Jan. 28, 2021

(54) SECURE ADDRESS TRANSLATION SERVICES PERMISSION TABLE FOR TRUST DOMAIN EXTENSIONS

(71) Applicant: Intel Corporation, Santa Clara, CA (US)

(72) Inventors: Anna Trikalinou, Hillsboro, OR (US); Ramya Jayaram Masti, Hillsboro, OR (US); Utkarsh Kakaiya, Folsom, CA (US); David Koufaty, Portland, OR (US); Vedvyas Shanbhogue, Austin, TX (US)

(73) Assignee: Intel Corporation, Santa Clara, CA (US)

(21) Appl. No.: 17/032,789

(22) Filed: Sep. 25, 2020

(51) Int. Cl. G06F 3/06

(52) U.S. Cl. CPC G06F 3/0622; G06F 3/0679; G06F 3/0655

(57) ABSTRACT

An apparatus to facilitate security of a shared memory resource is disclosed. The apparatus includes a memory device to store memory data a system agent to receive requests from one or more input/output (I/O) devices to access the memory data memory and trusted translation components having trusted host physical address (HPA) permission tables (HPTs) to validate memory address translation requests received from trusted I/O devices to access pages in memory associated with trusted domains.

### BACKGROUND OF THE DESCRIPTION

Trusted computing platforms have defined secure boot and device authentication that provide security for hardware components included in the platform. Trust Domain Extensions (TDX) provides a trusted platform that is implemented to guarantee isolation and data security (e.g., confidentiality and integrity) of tenant virtual machines (VMs) in cloud servers in the presence of a potentially untrustworthy cloud service provider (CSP). An untrustworthy CSP may manifest itself via a malicious virtual machine monitor and/or a rogue system/infrastructure administrator.

### BRIEF DESCRIPTION OF THE DRAWINGS

So that the manner in which the above recited features can be understood in detail, a more particular description, briefly summarized above, may be had by reference to embodiments, some of which are illustrated in the appended drawings. It is to be noted, however, that the appended drawings illustrate only typical embodiments and are therefore not to be considered limiting of its scope, for the disclosure may admit other equally effective embodiments.

FIG. 1 illustrates one embodiment of a computing device.

FIG. 2 illustrates one embodiment of a platform.

FIGS. 3A & 3B illustrate other embodiments of a platform.

FIG. 4 is a block diagram illustrating how various portions of a host physical address (HPA) are used to walk through a multi-level HPT in accordance with an embodiment.

FIG. 5A illustrates one embodiment of a flow diagram for implementing shared and private HPT tables.

FIG. 5B illustrates one embodiment of a sequence diagram for implementing shared and private HPT tables.

FIGS. 6A & 6B illustrate embodiments of a process for adding a page.

FIG. 7A & 7B illustrate embodiments of a process for removing a page.

FIG. 8A & 8B illustrates other embodiments of a process for adding a page.

FIG. 9A & 9B illustrates other embodiments of a process for removing a page.

FIG. 10 illustrates one embodiment of a schematic diagram of an illustrative electronic computing device.

### DETAILED DESCRIPTION

In the following description, numerous specific details are set forth to provide a more thorough understanding. However, it will be apparent to one of skill in the art that the embodiments may be practiced without one or more of these specific details. In other instances, well-known features have not been described in order to avoid obscuring the embodiments.

In embodiments, trusted host physical address (HPA) permission tables (HPTs) are implemented to validate memory address translation requests received from trusted I/O devices to access pages in memory associated with trusted domains. In further embodiments, the trusted HPTs comprises shared HPTs to validate translation requests associated with shared memory pages and secure HPTs to validate translation requests associated with private memory pages.

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

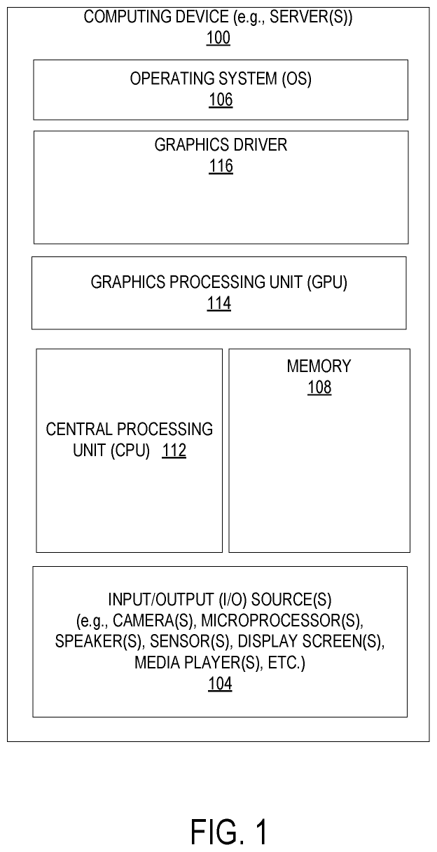

FIG. 1 illustrates one embodiment of a computing device 100. According to one embodiment, computing device 100 comprises a computer platform hosting an integrated circuit (“IC”), such as a system on a chip (“SoC” or “SOC”), integrating various hardware and/or software components of computing device 100 on a single chip. As illustrated, in one embodiment, computing device 100 may include any number and type of hardware and/or software components, such as (without limitation) graphics processing unit 114 (“GPU” or simply “graphics processor”), graphics driver 116 (also referred to as “GPU driver”, “graphics driver logic”, “driver logic”, user-mode driver (UMD), UMD, user-mode driver framework (UMDF), UMDF, or simply “driver”), central processing unit 112 (“CPU” or simply “application processor”), memory 108, network devices, drivers, or the like, as well as input/output (I/O) sources 104, such as touchscreens, touch panels, touch pads, virtual or regular keyboards, virtual or regular mice, ports, connectors, etc. Computing device 100 may include operating system (OS) 106 serving as an interface between hardware and/or physical resources of computing device 100 and a user.

It is to be appreciated that a lesser or more equipped system than the example described above may be preferred for certain implementations. Therefore, the configuration of computing device 100 may vary from implementation to implementation depending upon numerous factors, such as price constraints, performance requirements, technological improvements, or other circumstances.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The terms “logic”, “module”, “component”, “engine”, and “mechanism” may include, by way of example, software or hardware and/or a combination thereof, such as firmware.

Embodiments may be implemented using one or more memory chips, controllers, CPUs (Central Processing Unit), microchips or integrated circuits interconnected using a motherboard, an application specific integrated circuit (ASIC), and/or a field programmable gate array (FPGA). The term “logic” may include, by way of example, software or hardware and/or combinations of software and hardware.

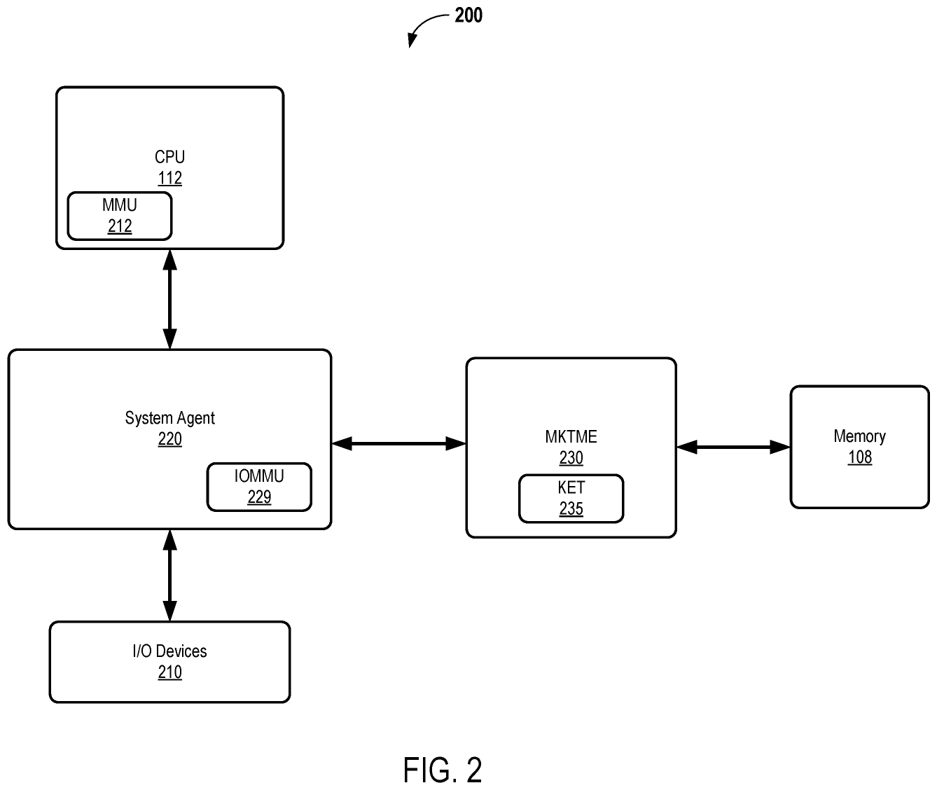

FIG. 2 illustrates one embodiment of a platform 200. According to one embodiment, platform 200 comprises a TDX platform that provides isolation and data security of tenant VMs in cloud servers. Platform 200 includes a system agent 220 and a Multi-Key Total Memory Encryption (MKTME) engine 230 coupled between CPU 112 and memory 108. In one embodiment, each secure VM operating on platform 200 is referred to as a Trusted Domain (TD), and a corresponding virtual machine monitor (VMM) is implemented to monitor each of the TDs. In a further embodiment, memory 108 comprises a shared resource having private components (e.g., pages) associated with each TD (e.g., TD private memory). In such an embodiment, each component of memory 108 associated with a TD is encrypted and has its integrity protected using a unique key.

A key ID, which is not known to a VMM, may be generated by CPU 112 upon generation of a TD and stored at a Key Encryption Table (KET) 235 within MKTME engine 230. In one embodiment, MKTME engine 230 is a cryptographic engine that is implemented to encrypt data to be stored in, and decrypt data that is to be read from, memory 108. Thus, data stored in TD private memory is encrypted by MKTME engine 230 using the key, while data read from the TD private memory is decrypted by MKTME engine 230. In a further embodiment, key identifiers (or KeylDs) are implemented to index KET 235. A KeyID for an active TD private memory access (e.g., identified by Private/Shared Bit in a guest physical address (GPA)) is stored in a memory management unit (MMU) 212 in CPU 112 and is transported through Host Physical Address (HPA) bits.

Platform 200 also includes one or more input/output (I/O) devices coupled to system agent 220 via an interface (e.g., a peripheral component interconnect express (PCIe) bus) and may perform direct memory accesses (DMAs) of TD private memory via system agent 220. In one embodiment, system agent 220 comprises an I/O memory management unit (IOMMU) 229 to facilitate DMA access requests by an device 210. To perform secure DMAs, the authenticity/identity of device requests (e.g., read/write over PCIe) are confirmed.

Platform 200 may also be implemented to perform address translations via Address Translation Services (ATS). ATS is an extension to the PCIe protocol. The current version of ATS is part of the PCIe specification, currently 4.0, which is maintained by the PCI Special Interest Group (PCI-SIG) and which can be accessed by members at https://pcisig.com/specifications/may be referred to herein as the “ATS Specification.” ATS enables a PCI-E device (e.g., I/O device 210) to request address translations, from a virtual address (VA) to a physical address (PA), from IOMMU 229. This capability allows the I/O device to store the resulting translations internally, in a Device Translation Lookaside Buffer (Dev-TLB), and directly use the resulting PA to access memory, either via the PCI-E interface or via a cache-coherent interface like Compute Express Link (CXL). However, a TDX platform implementing ATS may render the platform memory susceptible to attacks from malicious ATS devices (e.g., VMMs (or hypervisors))

According to one embodiment, a memory access control mechanism is provided to ensure that devices (e.g., graphics processing units (GPUs), FPGAs, etc.) using the ATS protocol can only access physical memory (e.g., TD private memory) that is explicitly assigned by platform 200. In a further embodiment, platform implements HPA Permission Tables (HPTs) to validate device translated requests to HPAs and guarantee that a device is only able to access (e.g., read and/or write) memory to which the device has been explicitly granted access.

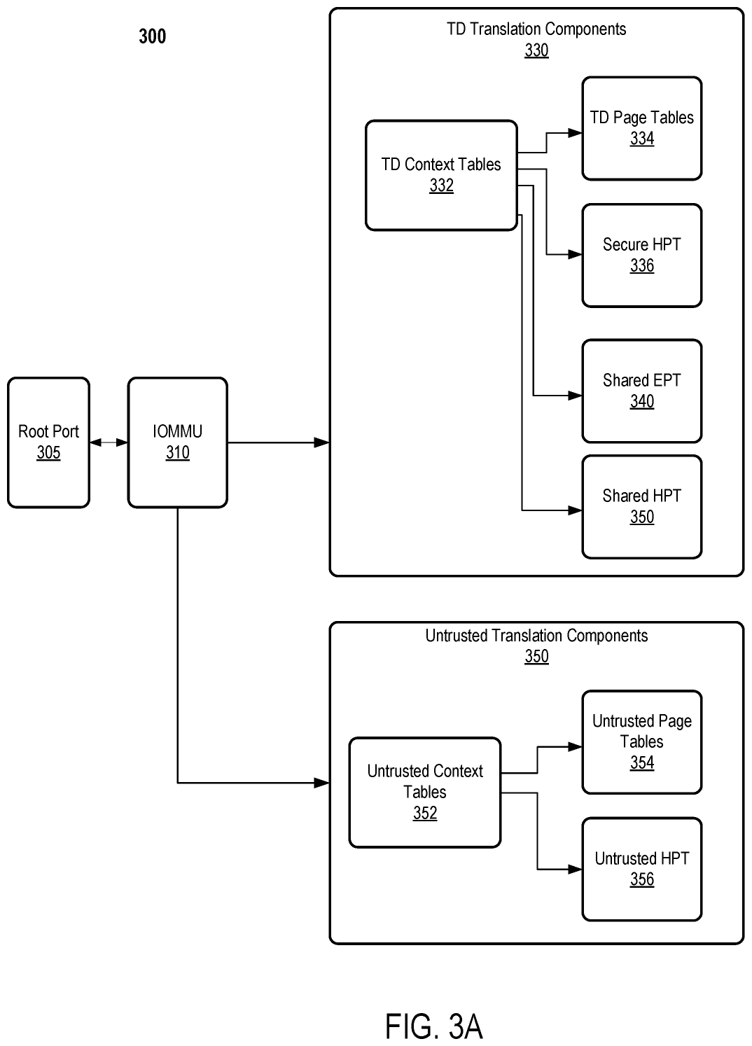

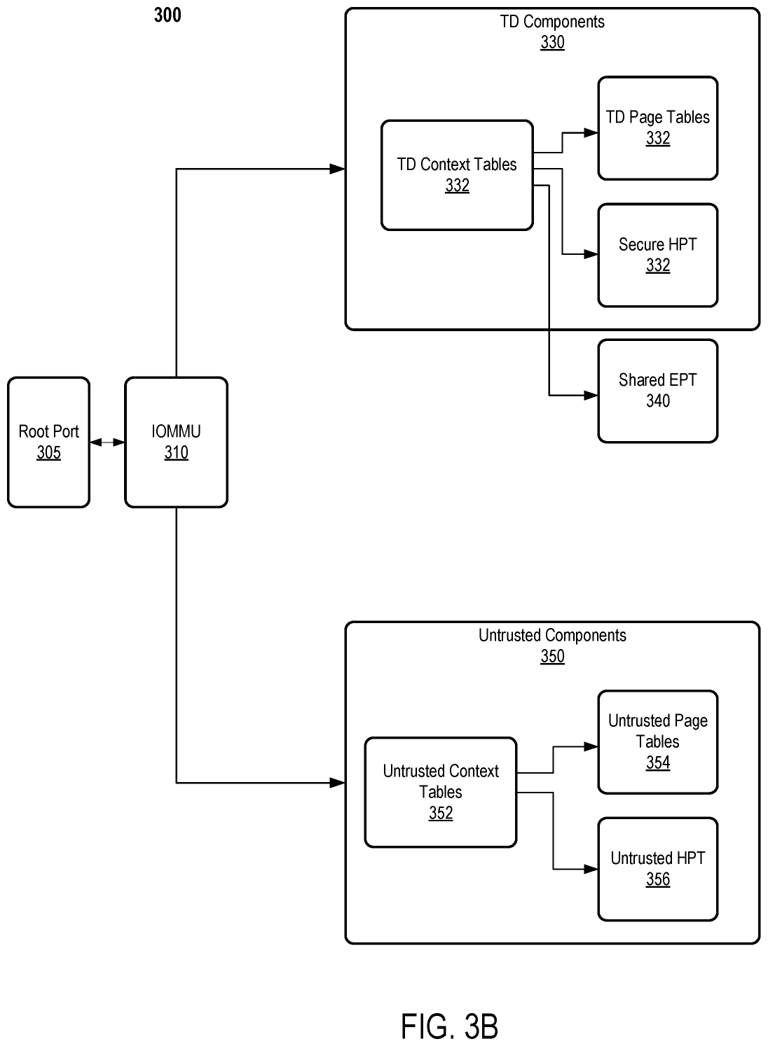

FIGS. 3A & 3B illustrate embodiments of a platform 300 implemented to provide confidentiality and integrity protection for platform tenants from hypervisors. Referring to FIG. 3A, platform 300 includes IOMMU 310 coupled to trusted (or TD) translation components 330 and untrusted translation components 350. According to one embodiment, platform 300 includes root port 305 to receive PCIe messages from I/O devices. In such an embodiment, root port 305 is configured to operate in both a TDX mode and a non-TDX mode. Thus, a platform 300 tenant may choose whether to operate in a TDX mode (e.g., where the hypervisor is outside the tenant's Trusted Computing Base (TCB)) or in a legacy mode (e.g., where the hypervisor is inside the tenant's TCB).

Whenever an ATS Translated Request is received from a TDX-capable device including TDX tenant workload transactions, root port 305 sets a bit (“is_trusted”) bit high (or 1) in a PCIe ATS Translated Request message. However, root port 305 sets the is_trusted bit low (or 0) upon a determination that the ATS Transaction is not part of a TDX tenant workload. In one embodiment, the is_trusted bit is used by IOMMU 310 to whether the translation request is trusted or untrusted. Trusted transactions are forwarded to TD translation components 330, while untrusted transactions are forwarded to untrusted translation components 350.

TD translation components 330 and untrusted translation components 350 each include a separate set of context tables (e.g., 332 and 352, respectively). In one embodiment, IOMMU 310 walks the context tables using the Bus, Device, Function and Process Address Space ID (PASID) information included in a Requestor Identifier (ReqID) received in the transaction. Thus, IOMMU 310 finds a PASID table entry that includes metadata for a device process that generated the device memory request.

TD translation components 330 and untrusted translation components 350 also include separate sets of page tables (e.g., 334 and 354, respectively). In one embodiment, IOMMU 310 uses the metadata from the PASID table entry to access first level page tables (e.g., to perform Guest Virtual Address to Guest Physical Address translations) and second level page tables (e.g., to perform Guest Physical Address to Host Physical Address translations).

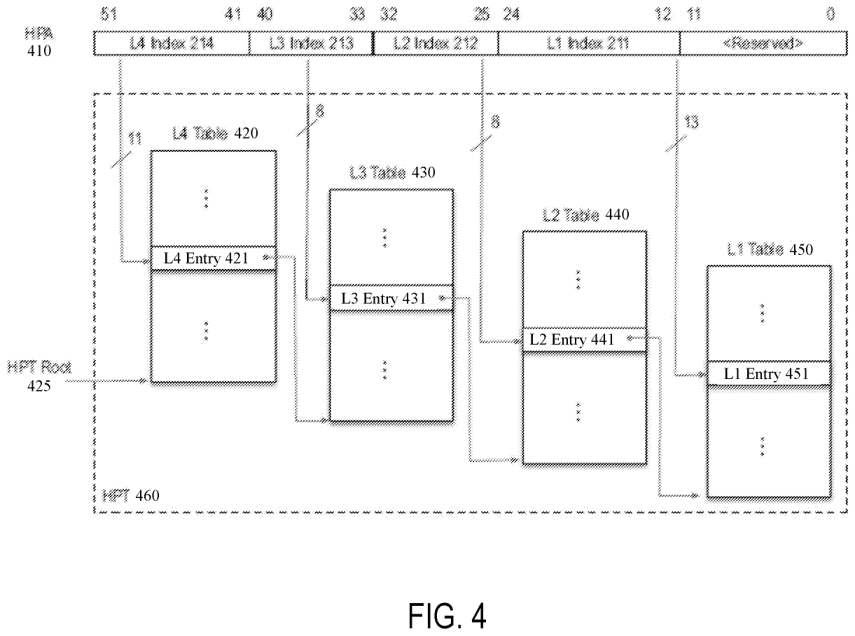

Additionally, TD translation components 330 and untrusted translation components 350 include separate sets of HPTs (e.g., 336 and 356, respectively). IOMMU 310 uses the metadata from the PASID table entry to access an walk an HPT to validate the Translated Requests to HPAs. FIG. 4 is a block diagram illustrating how various portions of a host physical address (HPA) 410 are used to walk through a multi-level HPT 460 in accordance with an embodiment. In the context of the present example, HPT 460 is organized as a hierarchical table, similar to how address translation page tables are organized. Various portions of HPA 410, including an L4 index 414, an L3 index 413, an L2 index, and an L1 index 411 in combination with HPT root 425 are used to retrieve permission entries (e.g., L4 entry 421, L3 entry 431, L2 entry 441 and/or L1 entry 451) from HPT 460. While in the context of the present example, HPA 410 is mapped based on a 4-level hierarchy, other embodiments may feature more or fewer levels may be used to represent HPT 460 depending upon the particular implementation.

One difference between the HPT 460 and regular address translation page tables is that the page access permissions can be tightly packed, since each set of page access permissions is much smaller than a regular address translation page table entry (e.g., from 2 to 4 bits versus 64-bits for a leaf entry of many existing address translation page table formats). As such, multiple sets of page access permissions be packed into a single cache line to achieve good spatial locality.

Another difference between the HPT 460 and other address translation page table formats is that in one embodiment permission entries of one or more levels of the HPT 460 function both as a leaf and non-leaf entries. For example, an L2 entry (e.g., L2 entry 441 holds page access permissions for pages of a first page size (e.g., 2MB pages) and also a pointer to page access permissions for any region of the first page size that is fractured into a second page size (e.g., 4KB pages). This dual function entry format facilitates support of page access permissions for pages of different sizes. For instance, page access permissions specified within an L1 entry (e.g., L1 entry 451) refer to permissions for accessing a page of the second page size (e.g., 4KB), page access permissions specified within an L2 entry refer to permissions for accessing a page of the first page size (e.g., 2MB), and page access permissions within an L3 entry refer to permissions for accessing a page of a third page size (e.g., 1GB). In alternative embodiments, a fixed page size may be used and the permission entry format may be simplified accordingly.

Assuming that a system maps 52 bits of physical address space, FIG. 4 conceptually illustrates how the HPT walk is performed. In other embodiments, the particular physical address space, the number of levels of the hierarchy and the number and type of page sizes used in the context of the examples provided herein are not intended to be limiting and will be able to generalize the approach described herein to other physical address spaces, different hierarchical structures and differing numbers and/or types of page sizes. Depending upon the particular implementation, the HPT walk may be performed for translated requests and can optionally be performed for translation requests. HPT lookup processing can also be accelerated using HPT caches as described below.

Initially, a pointer to HPT root 425 and the size of the top-level table (e.g., L4 table 420) of the HPT 460 can be obtained based on the Bus/Device/Function (BDF) descriptor included within the request at issue a. Based on the size of the top-level table (e.g., 4KB, 8KB, 16KB or 32KB), if the request at issue relates to a page that is outside the scope of the HPT 460, the access is denied; otherwise, in the context of the present example, the L4 index 414 represented by the upper 11 bits (51:41) of the HPA 410 is used as an offset from a base address of the L4 table 420 specified by HPT root 425 to select an entry (e.g., L4 entry 421) from the L4 table 420. In one embodiment, the L4 entry 421 contains information (e.g., a valid bit) indicating whether a base address of the L3 table 430 specified within the L4 entry 421 is valid.

If the validity information indicates the base address of the L3 table 430 in the L4 entry 421 is invalid (e.g., the valid bit is 0), then the requesting device does not have permission for the HPA 410. Otherwise, if the validity information indicates the base address of the L3 table 430 in the L4 entry 421 is valid (e.g., the valid bit is 1), then the walk continues by using the base address of the L3 table 430 in combination with the L3 index 413 represented by the next 8 bits (40:33) of the HPA 410 to select an entry (e.g., L3 entry 431) from the L3 table 430.

In the context of the present example, L3 entries of the L3 table 430 can act as both a leaf, containing the page access permissions, or as an intermediate node. Hence, the page access permissions in the L3 entry 431 are checked. If the page access permissions indicate the page is readable or writable, then the HPT walk ends; otherwise, when the page is neither readable nor writable, the validity information of the L3 entry 431 is checked. If the validity information indicates the base address of the L2 table 440 in the L3 entry 431 is invalid, then the device has no permission for the HPA 410. Otherwise, if the validity information indicates the base address of the L2 table 440 in the L3 entry 431 is valid, then walk continues by using the base address of the L2 table 440 in combination with the L2 index 412 represented by the next 8 bits (32:45) of the HPA 410 to select an entry (e.g., L2 entry 441) from the L2 table 440. The L2 table 440 is walked similarly to the L3 table 430 and assuming the HPA 410 represents a page of the first size (e.g., a 4KB page), finally, the L1 entry 451 of the L1 table 450 will include the page access permissions of the HPA 410.

Referring back to FIG. 3A, a TD, in TDX, has access to memory that is exclusive to the tenant and is encrypted with one or more associated private keys. Additionally, the TD may also have access to shared memory that is encrypted with one or more shared key(s). Thus the TD's 1st level page tables are always private to the domain of the TD, while the 2^{nd} level page tables (or Extended Page Tables (EPTs)) are either managed by TDX software (e.g., if the memory is private to the TD) or by a hypervisor (e.g., if the memory is shared).

According to one embodiment, TD translation components include both secure HPT 336, as well as shared EPT 340 and shared HPT 350. In such an embodiment, physical pages that are private to the TD and encrypted with the TD's private key(s) are marked in the secure HPT 336, while physical pages that are shared between the TD and other VMs, TDs or the hypervisor are marked in shared HPT 350.

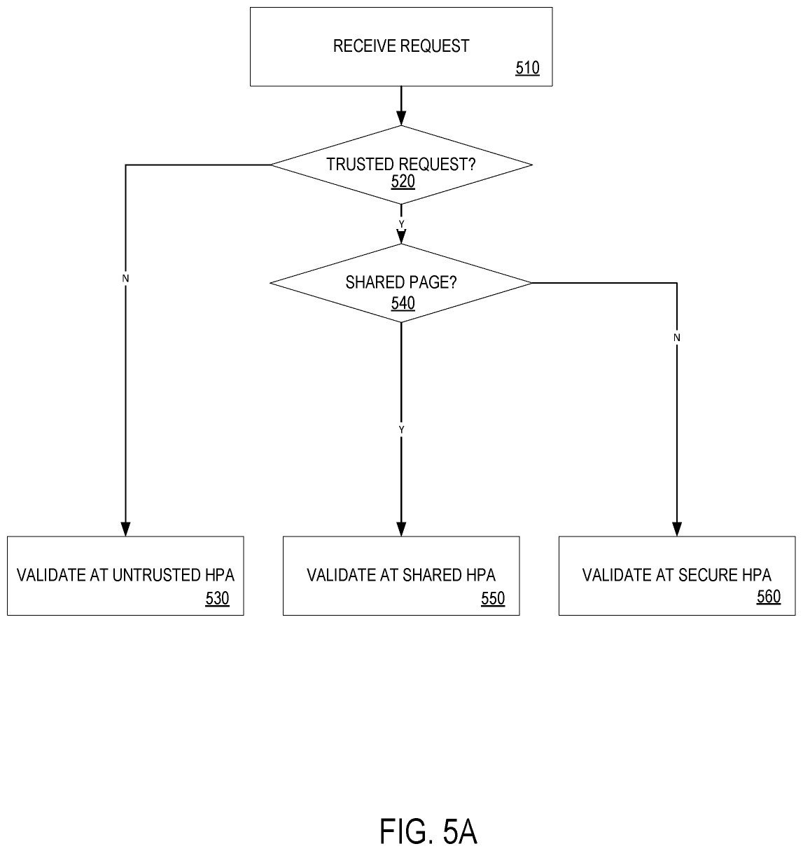

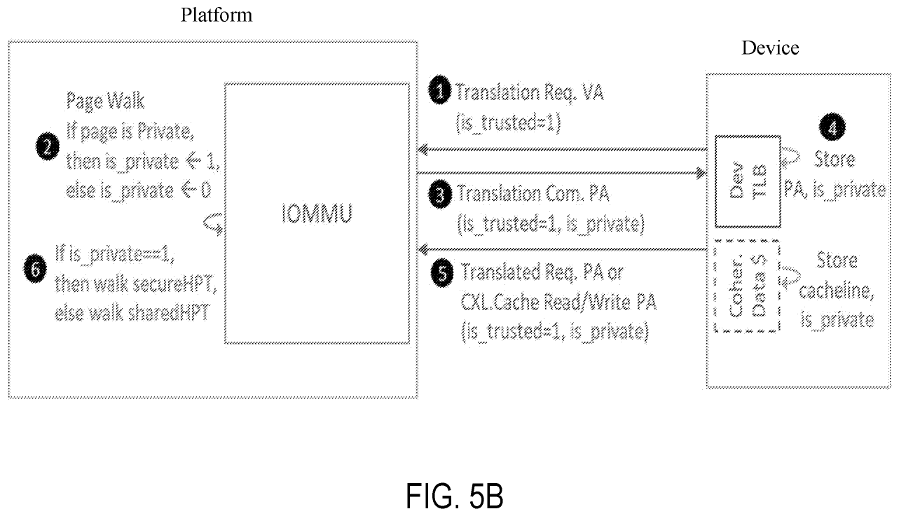

FIG. 5A illustrates one embodiment of a flow diagram for implementing shared and private HPT tables. At processing block 510, a memory address translation request is received from an I/O device. At decision block 520, a determination is made as to whether the request is a trusted request. If not, the translation request is validated at untrusted HPT 356, processing block 530. Otherwise, the request is a trusted request. At decision block 540, a determination is made as to whether the trusted translation request is associated with a shared memory page. If so, the trusted translation request is validated at shared HPT 350, processing block 550. Otherwise, the trusted translation request is validated at secure HPT 336, processing block 560.

FIG. 5B illustrates one embodiment of a sequence diagram for implementing shared and private HPT tables. At phase 1, a translation request is received at the IOMMU from a device as a part of a TDX workload (e.g., is_trusted=1). Thus, the IOMMU determines whether the TD's virtual address maps to a physical address that is private to the TD or to a shared physical page. In one embodiment, the IOMMU makes this determination by examining a GPA.Shared bit, as part of the page walk. At phase 2, the IOMMU sets a bit (e.g., “is_private”) indicating whether the physical address corresponds to a TD private (e.g., is_private=1) or shared page (e.g., is_private =0). Upon the translation completion, the IOMMU transmits the is_private to the device, phase 3. At phase 4, the device stores the is_private bit value as part of the device translation lookaside buffer (TLB). In Computer Express Link (CXL) cache coherent device embodiments, the is_private bit value is also stored in cache. At phase 5, the device transmits a PCIe ATS Translated Request (or a CXL.Cache Read/Write (e.g., WriteBack)), including the is_private bit value. At phase 6, the IOMMU uses the bit value to walk the secureHPT or the sharedHPT (e.g., walk secure HPT if is_private bit=1 and walk shared HPT if is_private bit=0).

In one embodiment, carrying the bit via the links and storing it may be implemented by re-purposing an unused physical address bit (e.g., 1 bit in the addr[63:52] range) to store the is_private information. The benefit of this approach is that no changes to the link protocols are required. In an alternative embodiment, the link protocols may be changed to the device TLB and, if applicable, the device coherent cache to carry and store the is_private bit.

Referring to FIG. 3B, another embodiment of platform 300 is shown in which HPT 332 is configured to include permissions for both a TD's private and shared pages. In this embodiment, a memory controller included within MKTME engine 230 is enhanced to maintain an is_private bit value per KeyID. However in other embodiments, the memory controller can derive the is_private bit value based on the KeyID. Thus, an is_private bit value is included each CPU memory access request issues for a memory transaction.

The memory controller subsequently looks up the KeyID for that transaction and the corresponding is_private bit value. The memory controller then compares the is_private bit value included in the request to the is_private bit value included in the KeyID. Access is granted upon a determination that there is a match. Otherwise, the memory controller signals an error and reports the illegal request if there is not a match.

For I/O device accesses, the is_private bit value is included in the HPT page permissions. In such an embodiment, the TDX software programs the is_private bit value into the secure HPT 332 to indicate whether a page is private or shared. Table 1 shows the HPT Page Permission Format including the is_private bit.

TABLE 1

| 3 | 2 | 1 | 0 |
|---|---|---|---|
| Reserved | is_private | Write | Read |

Based on the is_private bit included in the HPT Page Permission, IOMMU 310 walks secure HPT 332 in response to a device ATS/CXL.Cache Request in order to determine whether the I/O device from which a request has been received is allowed to access the given physical address. Upon a determination that the memory access is permitted, IOMMU 310 retrieves the is_private bit value from the secure HPT 332 entry and propagates the is_private bit value to MKTME engine 230 for future accesses. Table 2 shows a truth table of platform 300 behavior in response to a device PCIe ATS Translated Request, or a CXL.Cache Read/Write request.

TABLE 2

| PCIe/ | PCIe/ | | | |
|---|---|---|---|---|
| CXL | CXL | Page | | Flow for Option 2 |
| Is_ | Is_ | Security | | (assume is_private |
| trusted | private | (ground | | bit in PCIe/CXL.$ |
| bit | bit | truth) | Flow for Option 1 | message) |
| 0 | 0 | Private | Assuming MKMTE: | Same as Option 1 |
| | | | 1. Check Legacy HPT | |
| | | | (accessed by VMM) | |
| | | | 2. For is_private = 0 | |
| | | | and the page being | |
| | | | marked as private, | |
| | | | S-MKTME will | |
| | | | block | |
| 0 | 0 | Shared | 1. Check Legacy HPT | |
| | | | (accessed by VMM) | |
| | | | 2. MKTME will allow | |
| 0 | 1 | Private | IOMMU will respond | |
| | | | to device with | |
| | | | ″Unsupported | |
| | | | Request″. | |
| 0 | 1 | Shared | IOMMU will respond | |
| | | | to device with | |
| | | | ″Unsupported | |
| | | | Request″. | |
| 1 | 0 | Private | 1. Check SharedHPT | 1. Check SecureHPT |
| | | | (accessed by VMM) | (accessed by |
| | | | 2. For is_private = 0 | SEAM) - Should |
| | | | and the page being | always fail and |
| | | | marked as private, | respond to device |
| | | | S-MKTME will block | with “Unsupported |
| | | | | Request” |
| 1 | 0 | Shared | 1. Check SharedHPT | 1. Check SecureHPT |
| | | | (accessed by VMM) | (accessed by SEAM) |
| | | | 2. MKTME will allow | 2. MKTME will |
| | | | | allow |
| 1 | 1 | Private | 1. Check SecureHPT | 1. Check SecureHPT |
| | | | (accessed by SEAM) | (accessed by SEAM) |
| | | | 2. MKTME will allow | 2. MKTME will |
| | | | | allow |
| 1 | 1 | Shared | 1. Check SecureHPT | 1. Check SecureHPT |
| | | | (accessed by SEAM) - | (accessed by |
| | | | should always fail | SEAM) - should |
| | | | and respond to device | always fail and |
| | | | with “Unsupported | respond to device |
| | | | Request” | with “Unsupported |
| | | | | Request” |

According to one embodiment, the SecureHPT is built and updated by the TDX software, while the shared HPT is built and maintained by a hypervisor. In addition, the Secure HPT can be either encrypted with a reserved key or with the TD's private key. Encrypting the SecureHPT with the TD private key allows for easy TD memory accounting (“charge” the TD for the extra memory of storing the secure HPT, as opposed to the TDX software). However, instances in which the secure HPT may represent permissions of multiple TDs (e.g., when a device that is used by multiple TDs does not send PASID along with an ATS Translated Request), the secure HPT is encrypted with a TDX software reserved key.

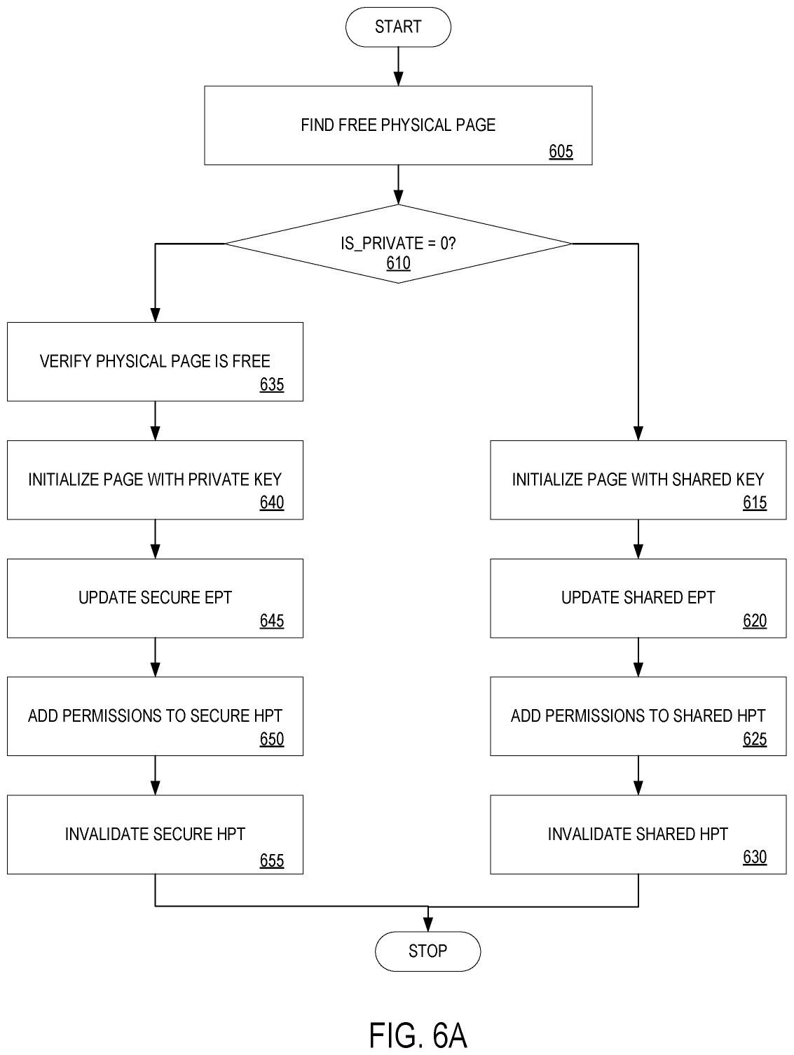

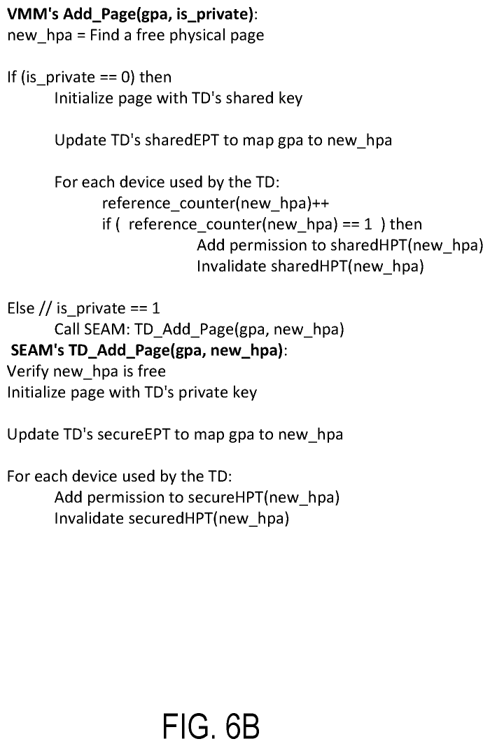

In one embodiment, pages may be added to or removed from a TD. FIG. 6A is a flow diagram illustrating one embodiment of a process for adding a page according to platform 300 in FIG. 3A. At processing block 605, a VMM finds a free physical page (e.g., new_hpa). At decision block 610, a determination is made as to whether the new page is shared (e.g., is_private=0). If so, the VMM initializes the page with the TD's shared key, processing block 615. At processing block 620, the shared EPT associated with the TD is updated to map the gpa to new_hpa. At processing block 625, a permission is then added to a shared HPT entry for each device used by the TD. At processing block 630, the shared HPT is invalidated.

Upon a determination at decision block 610 that the page is to be private (e.g., is_private=1), the TDX software verifies whether the new_hpa is available and initializes the page with the private key associated with the TD, processing block 635. At processing block 640, the page is initialized with the private key. At processing block 645, the secure EPT is updated to map gpa to new_hpa. At processing block 650, a permission is added to a secured HPT entry for each device used by the TD. At processing block 655, the shared HPT entry is invalidated for each device used by the TD. FIG. 6B illustrates one embodiment of source code to add a page.

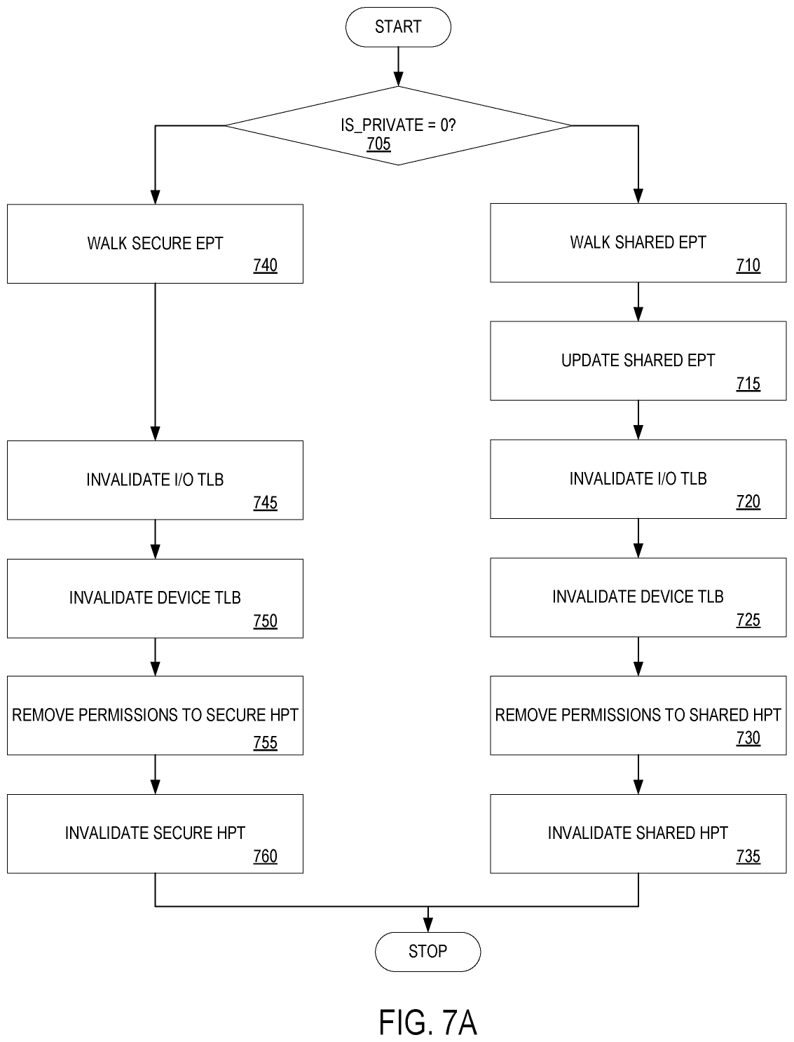

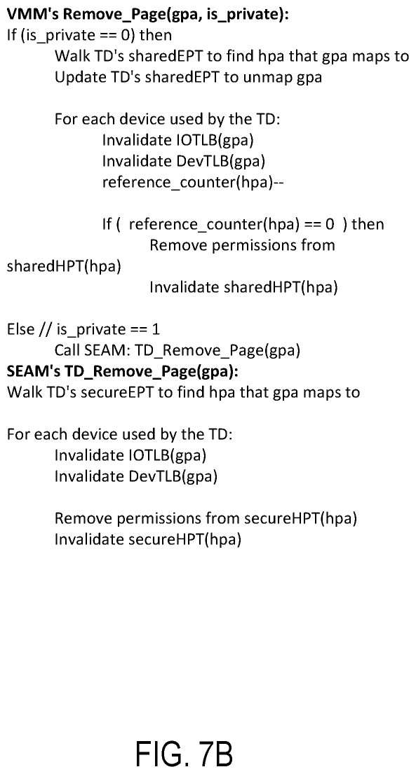

FIG. 7A is a flow diagram illustrating one embodiment of a process for removing a page according to platform 300 in FIG. 3A. At decision block 705, a determination is made by a VMM as to whether the page to be removed is shared (e.g., is_private=0). If so, the shared EPT associated with the TD is walked to find the hpa to which the gpa maps, processing block 710. At processing block 715, the shared EPT associated with the TD is updated to unmap the gpa. At processing block 720, the I/O TLB is invalidated for each device that is used by the TD. At processing block 725, the device TLB is invalidated for each device that is used by the TD. At processing block 730, permissions are removed from the shared HPT entry for each device used by the TD. At processing block 735, the shared HPT entry for each device used by the TD is invalidated.

Upon a determination at decision block 705 that the page is private (e.g., is private=1), the TDX software walks the Secure EPT to find the hpa to which the gpa maps, processing block 740. At processing block 745, the I/O TLB is invalidated for each device used by the TD. At processing block 750, the device TLB is invalidated for each device used by the TD. At processing block 755, permissions are removed from the secure HPT entry. At processing block 760, the secure HPT entry is invalidated. FIG. 7B illustrates one embodiment of source code to remove a page.

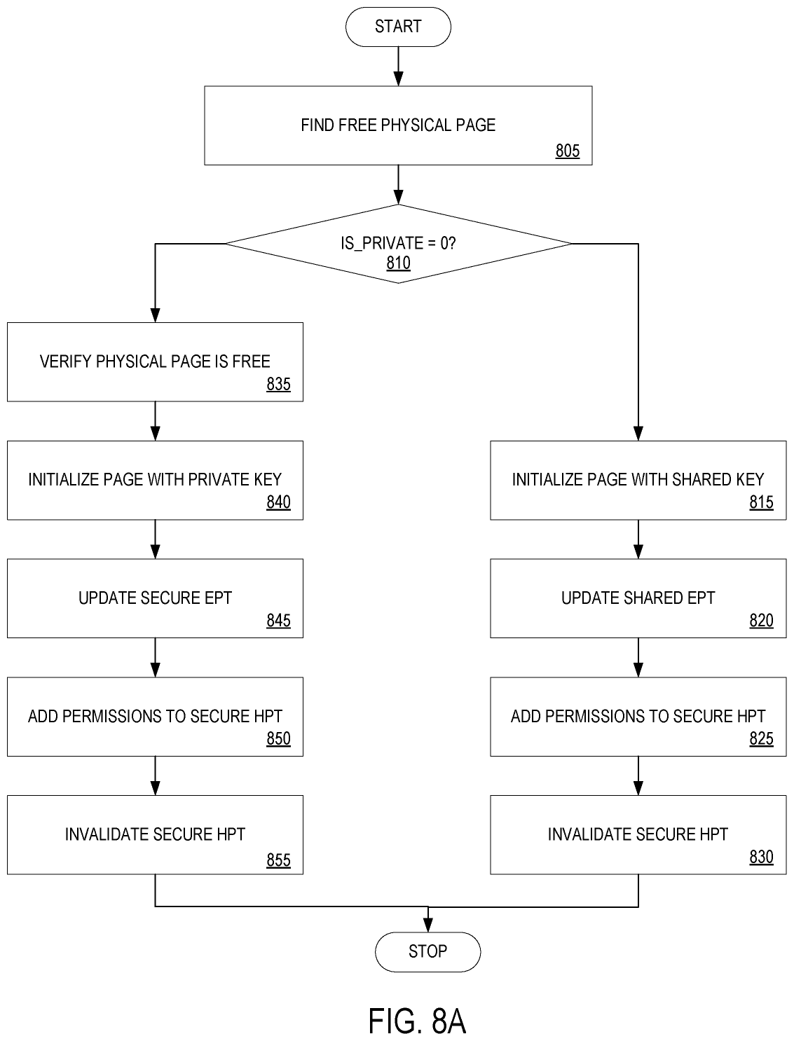

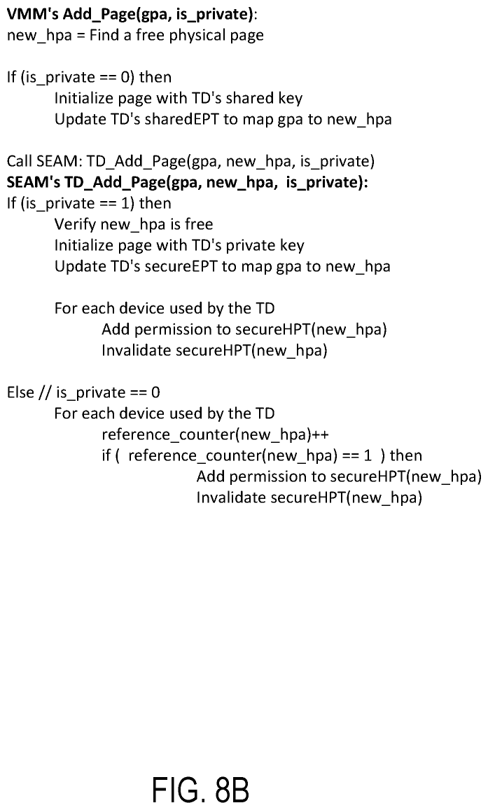

FIG. 8A is a flow diagram illustrating one embodiment of a process for adding a page according to platform 300 in FIG. 3B. At processing block 805, the VMM finds a free physical page (e.g., new_hpa). At decision block 810, a determination is made as to whether the new page is shared (e.g., is_private=0). If so, the VMM initializes the page with the TD's shared key, processing block 815. Subsequently, the VMM calls the TDX software to add the page. At processing block 820, the shared EPT associated with the TD is updated to map the gpa to new_hpa. At processing block 825, a permission is then added to a secure HPT entry for each device used by the TD. At processing block 830, the secure HPT is invalidated.

Upon a determination at decision block 810 that the page is to be private (e.g., is_private=1), the TDX software verifies whether the new_hpa is available and initializes the page with the private key associated with the TD, processing block 835. At processing block 840, the page is initialized with the private key. At processing block 845, the secure EPT is updated to map gpa to new_hpa. At processing block 850, a permission is added to a secured HPT entry for each device used by the TD. At processing block 855, the shared HPT is invalidated. FIG. 8B illustrates one embodiment of source code to add a page.

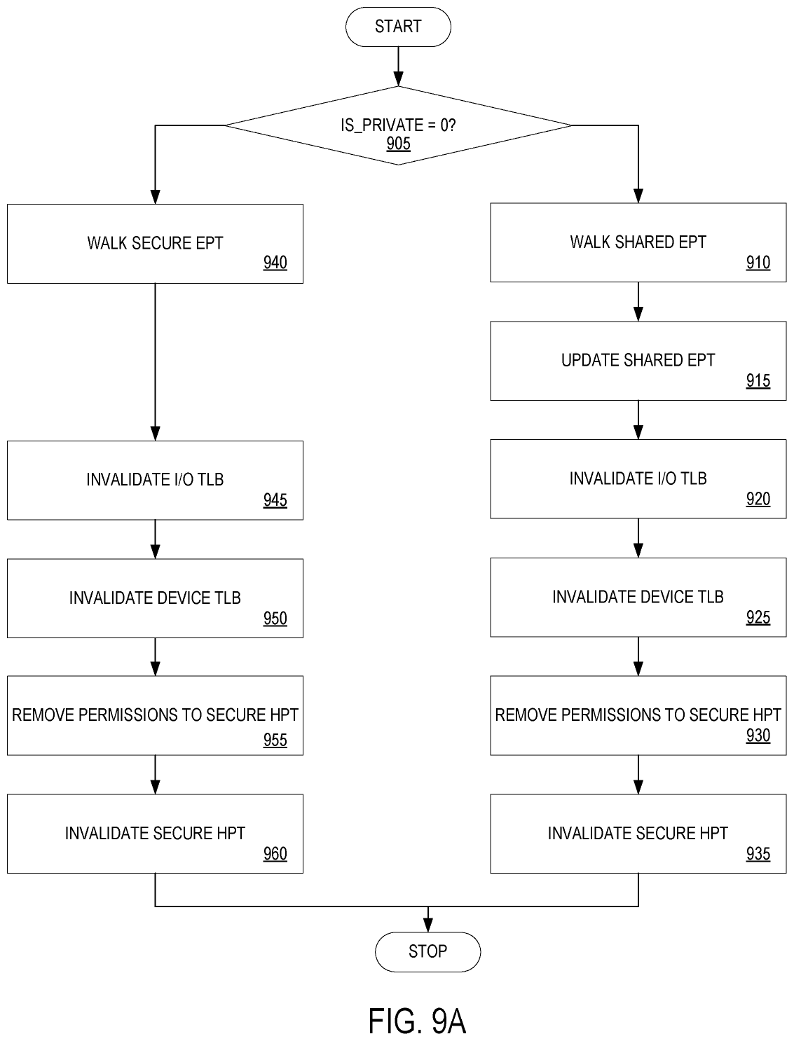

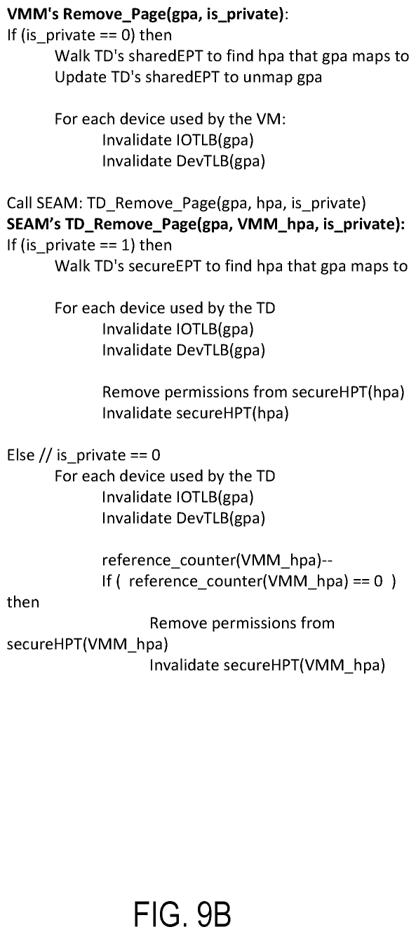

FIG. 9A is a flow diagram illustrating one embodiment of a process for removing a page according to platform 300 in FIG. 3B. At decision block 905, a determination is made by the VMM as to whether the page to be removed is shared (e.g., is_private=0). If so, the shared EPT associated with the TD is walked to find the hpa to which the gpa maps, processing block 910. At processing block 915, the shared EPT associated with the TD is updated to unmap the gpa. At processing block 920, the I/O TLB is invalidated for each device that is used by the TD. Subsequently, the VMM calls the TDX software to remove the page. At processing block 925, the device TLB is invalidated for each device that is used by the TD. At processing block 930, permissions are removed from the secure HPT entry for each device used by the TD. At processing block 935, the secure HPT entry for each device used by the TD is invalidated.

Upon a determination at decision block 905 that the page is private (e.g., is_private=1), the TDX software walks the secure EPT to find the hpa to which the gpa maps, processing block 940. At processing block 945, the I/O TLB is invalidated for each device used by the TD. At processing block 950, the device TLB is invalidated for each device used by the TD. At processing block 955, permissions are removed from the secure HPT entry. At processing block 960, the secure HPT entry is invalidated. FIG. 9B illustrates one embodiment of source code to remove a page.

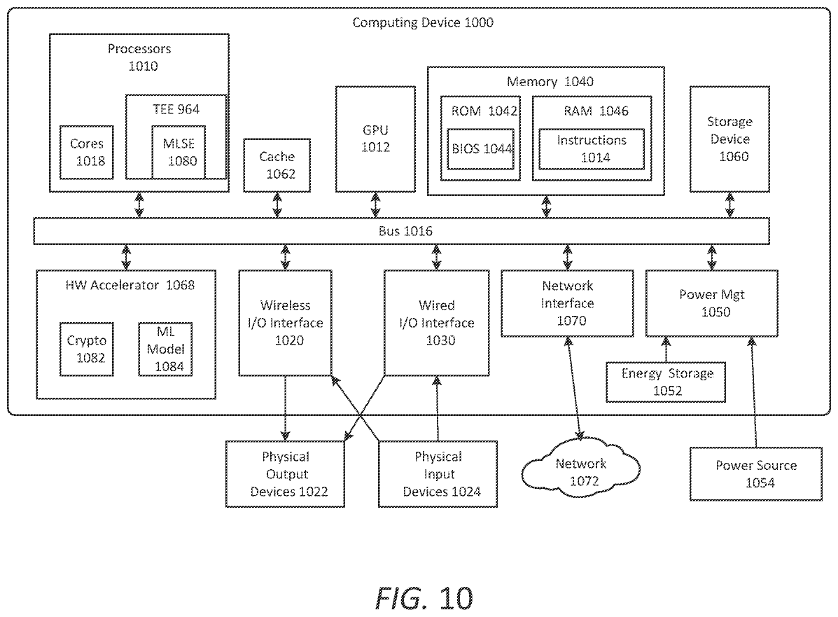

FIG. 10 is a schematic diagram of an illustrative electronic computing device to enable enhanced protection against adversarial attacks according to some embodiments. In some embodiments, the computing device 1000 includes one or more processors 1010 including one or more processors cores 1018 and a Trusted Execution Environment (TEE) 1064, the TEE including a machine learning service enclave (MLSE) 1080. In some embodiments, the computing device 1000 includes a hardware accelerator (HW) 1068, the hardware accelerator including a cryptographic engine 1082 and a machine learning model 1084. In some embodiments, the computing device is to provide enhanced protections against ML adversarial attacks, as provided in FIGS. 1-9.

The computing device 1000 may additionally include one or more of the following: cache 1062, a graphical processing unit (GPU) 1012 (which may be the hardware accelerator in some implementations), a wireless input/output (I/O) interface 1020, a wired 110 interface 1030, memory circuitry 1040, power management circuitry 1050, non-transitory storage device 1060, and a network interface 1070 for connection to a network 1072. The following discussion provides a brief, general description of the components forming the illustrative computing device 1000. Example, non-limiting computing devices 1000 may include a desktop computing device, blade server device, workstation, or similar device or system.

In embodiments, the processor cores 1018 are capable of executing machine-readable instruction sets 1014, reading data and/or instruction sets 1014 from one or more storage devices 1060 and writing data to the one or more storage devices 1060. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 1018 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 1000 includes a bus or similar communications link 1016 that communicably couples and facilitates the exchange of information and/or data between various system components including the processor cores 1018, the cache 1062, the graphics processor circuitry 1012, one or more wireless I/O interfaces 1020, one or more wired I/O interfaces 1030, one or more storage devices 1060, and/or one or more network interfaces 1070. The computing device 1000 may be referred to in the singular herein, but this is not intended to limit the embodiments to a single computing device 1000, since in certain embodiments, there may be more than one computing device 1000 that incorporates, includes, or contains any number of communicably coupled, collocated, or remote networked circuits or devices.

The processor cores 1018 may include any number, type, or combination of currently available or future developed devices capable of executing machine-readable instruction sets.

The processor cores 1018 may include (or be coupled to) but are not limited to any current or future developed single- or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 10 are of conventional design. Consequently, such blocks need not be described in further detail herein, as they will be understood by those skilled in the relevant art. The bus 1016 that interconnects at least some of the components of the computing device 1000 may employ any currently available or future developed serial or parallel bus structures or architectures.

The system memory 1040 may include read-only memory (“ROM”) 1042 and random access memory (“RAM”) 1046. A portion of the ROM 1042 may be used to store or otherwise retain a basic input/output system (“BIOS”) 1044. The BIOS 1044 provides basic functionality to the computing device 1000, for example by causing the processor cores 1018 to load and/or execute one or more machine-readable instruction sets 1014. In embodiments, at least some of the one or more machine-readable instruction sets 1014 cause at least a portion of the processor cores 1018 to provide, create, produce, transition, and/or function as a dedicated, specific, and particular machine, for example a word processing machine, a digital image acquisition machine, a media playing machine, a gaming system, a communications device, a smartphone, or similar.

The computing device 1000 may include at least one wireless input/output (I/O) interface 1020. The at least one wireless I/O interface 1020 may be communicably coupled to one or more physical output devices 1022 (tactile devices, video displays, audio output devices, hardcopy output devices, etc.). The at least one wireless I/O interface 1020 may communicably couple to one or more physical input devices 1024 (pointing devices, touchscreens, keyboards, tactile devices, etc.). The at least one wireless I/O interface 1020 may include any currently available or future developed wireless I/O interface. Example wireless I/O interfaces include, but are not limited to: BLUETOOTH®, near field communication (NFC), and similar.

The computing device 1000 may include one or more wired input/output (I/O) interfaces 1030. The at least one wired I/O interface 1030 may be communicably coupled to one or more physical output devices 1022 (tactile devices, video displays, audio output devices, hardcopy output devices, etc.). The at least one wired I/O interface 1030 may be communicably coupled to one or more physical input devices 1024 (pointing devices, touchscreens, keyboards, tactile devices, etc.). The wired I/O interface 1030 may include any currently available or future developed I/O interface. Example wired I/O interfaces include, but are not limited to: universal serial bus (USB), IEEE 1394 (“FireWire”), and similar.

The computing device 1000 may include one or more communicably coupled, non-transitory, data storage devices 1060. The data storage devices 1060 may include one or more hard disk drives (HDDs) and/or one or more solid-state storage devices (SSDs). The one or more data storage devices 1060 may include any current or future developed storage appliances, network storage devices, and/or systems. Non-limiting examples of such data storage devices 1060 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 1060 may include one or more removable storage devices, such as one or more flash drives, flash memories, flash storage units, or similar appliances or devices capable of communicable coupling to and decoupling from the computing device 1000.

The one or more data storage devices 1060 may include interfaces or controllers (not shown) communicatively coupling the respective storage device or system to the bus 1016. The one or more data storage devices 1060 may store, retain, or otherwise contain machine-readable instruction sets, data structures, program modules, data stores, databases, logical structures, and/or other data useful to the processor cores 1018 and/or graphics processor circuitry 1012 and/or one or more applications executed on or by the processor cores 1018 and/or graphics processor circuitry 1012. In some instances, one or more data storage devices 1060 may be communicably coupled to the processor cores 1018, for example via the bus 1016 or via one or more wired communications interfaces 1030 (e.g., Universal Serial Bus or USB); one or more wireless communications interfaces 1020 (e.g., Bluetooth®, Near Field Communication or NFC); and/or one or more network interfaces 1070 (IEEE 802.3 or Ethernet, IEEE 802.11, or Wi-Fi®, etc.).

Processor-readable instruction sets 1014 and other programs, applications, logic sets, and/or modules may be stored in whole or in part in the system memory 1040. Such instruction sets 1014 may be transferred, in whole or in part, from the one or more data storage devices 1060. The instruction sets 1014 may be loaded, stored, or otherwise retained in system memory 1040, in whole or in part, during execution by the processor cores 1018 and/or graphics processor circuitry 1012.

The computing device 1000 may include power management circuitry 1050 that controls one or more operational aspects of the energy storage device 1052. In embodiments, the energy storage device 1052 may include one or more primary (i.e., non-rechargeable) or secondary (i.e., rechargeable) batteries or similar energy storage devices. In embodiments, the energy storage device 1052 may include one or more supercapacitors or ultracapacitors. In embodiments, the power management circuitry 1050 may alter, adjust, or control the flow of energy from an external power source 1054 to the energy storage device 1052 and/or to the computing device 1000. The power source 1054 may include, but is not limited to, a solar power system, a commercial electric grid, a portable generator, an external energy storage device, or any combination thereof.

For convenience, the processor cores 1018, the graphics processor circuitry 1012, the wireless I/O interface 1020, the wired I/O interface 1030, the storage device 1060, and the network interface 1070 are illustrated as communicatively coupled to each other via the bus 1016, thereby providing connectivity between the above-described components. In alternative embodiments, the above-described components may be communicatively coupled in a different manner than illustrated in FIG. 10. For example, one or more of the above-described components may be directly coupled to other components, or may be coupled to each other, via one or more intermediary components (not shown). In another example, one or more of the above-described components may be integrated into the processor cores 1018 and/or the graphics processor circuitry 1012. In some embodiments, all or a portion of the bus 1016 may be omitted and the components are coupled directly to each other using suitable wired or wireless connections.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

Throughout the document, term “user” may be interchangeably referred to as “viewer”, “observer”, “speaker”, “person”, “individual”, “end-user”, and/or the like. It is to be noted that throughout this document, terms like “graphics domain” may be referenced interchangeably with “graphics processing unit”, “graphics processor”, or simply “GPU” and similarly, “CPU domain” or “host domain” may be referenced interchangeably with “computer processing unit”, “application processor”, or simply “CPU”.

It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, “software package”, and the like, may be used interchangeably throughout this document. Also, terms like “job”, “input”, “request”, “message”, and the like, may be used interchangeably throughout this document.

In various implementations, the computing device may be a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device may be any other electronic device that processes data or records data for processing elsewhere.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Embodiments may be provided, for example, as a computer program product which may include one or more transitory or non-transitory machine-readable storage media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Some embodiments pertain to Example 1 that includes an apparatus to facilitate security of a shared memory resource, comprising a memory device to store memory data, a system agent to receive requests from one or more input/output (I/O) devices to access the memory data memory and trusted translation components having trusted host physical address (HPA) permission tables (HPTs) to validate memory address translation requests received from trusted I/O devices to access pages in memory associated with trusted domains.

Example 2 includes the subject matter of Example 1, wherein the system agent determines whether a received request is a trusted translation request or an untrusted translation request.

Example 3 includes the subject matter of Examples 1 and 2, further comprising untrusted translation components having untrusted host physical address (HPA) permission tables (HPTs) to validate the untrusted translation request.

Example 4 includes the subject matter of Examples 1-3, wherein the trusted HPTs comprise shared HPTs to validate translation requests associated with shared memory pages and secure HPTs to validate translation requests associated with private memory pages.

Example 5 includes the subject matter of Examples 1-4, wherein the system agent sets a first bit value upon a determination that an address corresponding to the trusted translation request is associated with a shared memory page and sets a second bit value upon a determination that the address corresponding to the trusted translation request is associated with a private memory page.

Example 6 includes the subject matter of Examples 1-5, wherein the system agent transmits the bit value to an I/O device.

Example 7 includes the subject matter of Examples 1-6, wherein the system agent receives a second trusted translation request form the I/O device including the bit value and performs a walk of the shared HPTs or private HPTs based on the bit value.

Example 8 includes the subject matter of Examples 1-7, wherein each entry in the trusted HPTs comprises a bit value to indicate whether a memory page comprises a shared memory page or a private memory page.

Example 9 includes the subject matter of Examples 1-8, wherein the system agent determines whether an I/O device associated with the trusted translation request may access a memory page based on the bit value.

Example 10 includes the subject matter of Examples 1-9, further comprising a memory controller, wherein the system agent stores a bit value in the memory controller upon a determination the I/O device may access the memory page.

Some embodiments pertain to Example 11 that includes a method to facilitate security of a shared memory resource, comprising receiving a memory address translation request from an input/output (I/O) device, determining whether the translation request is a trusted translation request or an untrusted translation request and validating the translation request at trusted host physical address (HPA) permission tables (HPTs) associated with trusted domains upon a determination that the translation request is a trusted translation request.

Example 12 includes the subject matter of Example 11, further comprising validating the translation request at untrusted HPTs associated upon a determination that the translation request is an untrusted translation request.

Example 13 includes the subject matter of Examples 11 and 12, further comprising examining a bit value to determine whether the trusted translation request is associated with a shared memory page or associated with a private memory page.

Example 14 includes the subject matter of Examples 11-13, further comprising validating the translation request at the secure HPTs upon a determination that trusted translation request is associated with a private memory page.

Example 15 includes the subject matter of Examples 11-14, further comprising validating the translation request at the shared HPTs upon a determination that trusted translation request is associated with a shared memory page.

Some embodiments pertain to Example 16 that includes at least one computer-readable medium having instructions, which when executed by a processor, causes the processor to receive a memory address translation request from an input/output (I/O) device, determine whether the translation request is a trusted translation request or an untrusted translation request and validate the translation request at trusted host physical address (HPA) permission tables (HPTs) associated with trusted domains upon a determination that the translation request is a trusted translation request.

Example 17 includes the subject matter of Example 16, having instructions, which when executed by a processor, further causes the processor to validate the translation request at untrusted HPTs associated upon a determination that the translation request is an untrusted translation request.

Example 18 includes the subject matter of Examples 16 and 17, having instructions, which when executed by a processor, further causes the processor to examine a bit value to determine whether the trusted translation request is associated with a shared memory page or associated with a private memory page.

Example 19 includes the subject matter of Examples 16-18, having instructions, which when executed by a processor, further causes the processor to validate the translation request at the secure HPTs upon a determination that trusted translation request is associated with a private memory page.

Example 20 includes the subject matter of Examples 16-19, having instructions, which when executed by a processor, further causes the processor to validate the translation request at the shared HPTs upon a determination that trusted translation request is associated with a shared memory page.

The embodiments of the examples have been described above with reference to specific embodiments. Persons skilled in the art, however, will understand that various modifications and changes may be made thereto without departing from the broader spirit and scope as set forth in the appended claims. The foregoing description and drawings are, accordingly, to be regarded in an illustrative rather than a restrictive sense.

What is claimed is:

1. An apparatus to facilitate security of a shared memory resource, comprising:
a memory device to store memory data;
a system agent to receive requests from one or more input/output (I/O) devices to access the memory data memory; and
trusted translation components having trusted host physical address (HPA) permission tables (HPTs) to validate memory address translation requests received from trusted I/O devices to access pages in memory associated with trusted domains.

2. The apparatus of claim 1, wherein the system agent determines whether a received request is a trusted translation request or an untrusted translation request.

3. The apparatus of claim 2, further comprising untrusted translation components having untrusted HPTs to validate the untrusted translation request.

4. The apparatus of claim 2, wherein the trusted HPTs comprise:
shared HPTs to validate translation requests associated with shared memory pages; and
secure HPTs to validate translation requests associated with private memory pages.

5. The apparatus of claim 4, wherein the system agent sets a first bit value upon a determination that an address corresponding to the trusted translation request is associated with a shared memory page and sets a second bit value upon a determination that the address corresponding to the trusted translation request is associated with a private memory page.

6. The apparatus of claim 5, wherein the system agent transmits the bit value to an I/O device.

7. The apparatus of claim 6, wherein the system agent receives a second trusted translation request form the I/O device including the bit value and performs a walk of the shared HPTs or private HPTs based on the bit value.

8. The apparatus of claim 2, wherein each entry in the trusted HPTs comprises a bit value to indicate whether a memory page comprises a shared memory page or a private memory page.

9. The apparatus of claim 8, wherein the system agent determines whether an I/O device associated with the trusted translation request may access the memory page based on the bit value.

10. The apparatus of claim 9, further comprising a memory controller, wherein the system agent stores the bit value in the memory controller upon a determination the I/O device may access the memory page.

11. A method to facilitate security of a shared memory resource, comprising:
receiving a memory address translation request from an input/output (I/O) device;
determining whether the translation request is a trusted translation request or an untrusted translation request; and
validating the translation request at trusted host physical address (HPA) permission tables (HPTs) associated with trusted domains upon a determination that the translation request is the trusted translation request.

12. The method of claim 11, further comprising validating the translation request at untrusted HPTs associated upon a determination that the translation request is an untrusted translation request.

13. The method of claim 11, further comprising determining whether the trusted translation request is associated with a shared memory page or associated with a private memory page.

14. The method of claim 13, further comprising validating the translation request at secure HPTs upon a determination that trusted translation request is associated with a private memory page.

15. The method of claim 14, further comprising validating the translation request at shared HPTs upon a determination that trusted translation request is associated with a shared memory page.

16. At least one computer-readable medium having instructions, which when executed by a processor, causes the processor to:
receive a memory address translation request from an input/output (I/O) device;
determine whether the translation request is a trusted translation request or an untrusted translation request; and
validate the translation request at trusted host physical address (HPA) permission tables (HPTs) associated with trusted domains upon a determination that the translation request is the trusted translation request.

17. The computer-readable medium of claim 16, having instructions, which when executed by a processor, further causes the processor to validate the translation request at untrusted HPTs associated upon a determination that the translation request is an untrusted translation request.

18. The computer-readable medium of claim 16, having instructions, which when executed by a processor, further causes the processor to determine whether the trusted translation request is associated with a shared memory page or associated with a private memory page.

19. The computer-readable medium of claim 18, having instructions, which when executed by a processor, further causes the processor to validate the translation request at secure HPTs upon a determination that the trusted translation request is associated with a private memory page.

20. The computer-readable medium of claim 19, having instructions, which when executed by a processor, further causes the processor to validate the translation request at shared HPTs upon a determination that the trusted translation request is associated with the shared memory page.
